(19) United States
(12) Patent Application Publication
(10) Pub. No.: US 2021/0194325 A1
(43) Pub. Date: Jun. 24, 2021

(54) ROTARY ELECTRIC MACHINE UNIT

(71) Applicant: HONDA MOTOR CO., LTD., Tokyo (JP)

(72) Inventors: Tadashi YAMAGUCHI, Saitama (JP); Takuro KAMADA, Saitama (JP); Masaki OGAMI, Saitama (JP)

(73) Assignee: HONDA MOTOR CO., LTD., Tokyo (JP)

(21) Appl. No.: 17/119,298

(22) Filed: Dec. 11, 2020

(30) Foreign Application Priority Data
Dec. 18, 2019 (JP) 2019-228478

(51) Int. Cl. H02K 9/19; H02K 7/20; H02K 11/225; H02K 24/00

(52) U.S. Cl. CPC H02K 9/19; H02K 24/00; H02K 11/225; H02K 7/20

(57) ABSTRACT

A rotary electric machine unit includes: a first rotary electric machine having a first rotation axis extending in a horizontal direction; a second rotary electric machine having a second rotation axis extending in parallel with the first rotation axis and positioned lower than the first rotation axis; a first rotation speed detection device arranged at a position overlapping with the first rotary electric machine as viewed from an axial direction; a second rotation speed detection device arranged at a position overlapping with the second rotary electric machine as viewed from the axial direction; and a refrigerant supply portion configured to supply refrigerant to the first rotary electric machine. The first rotation speed detection device and the second rotation speed detection device are arranged on one axial end side of the first rotary electric machine and the second rotary electric machine in the axial direction.

### CROSS-REFERENCE TO RELATED APPLICATIONS

The present application claims the benefit of priority of Japanese Patent Application No. 2019-228478, filed on Dec. 18, 2019, the content of which is incorporated herein by reference.

### TECHNICAL FIELD

The present invention relates to a rotary electric machine unit mounted on an electric vehicle or the like.

### BACKGROUND ART

In the related art, a rotary electric machine unit including a plurality of rotary electric machines has been known as a rotary electric machine unit mounted on an electric vehicle or the like. For example, JP-A-2009-254144 discloses a rotary electric machine unit including a first rotary electric machine having a first rotation axis extending in a horizontal direction and a second rotary electric machine having a second rotation axis extending in parallel with the first rotation axis.

In this type of rotary electric machine unit, a higher cooling efficiency is required in association with a higher output of the rotary electric machine.

However, in the rotary electric machine unit of JP-A-2009-254144, for example, when a cooling supply portion is provided above a second rotary electric machine (MG2), refrigerant supplied from the cooling supply portion flows down to a differential unit (DF) after cooling the second rotary electric machine (MG2). Therefore, since the refrigerant supplied from the cooling supply portion cools only the second rotary electric machine (MG2) and does not cool the first rotary electric machine (MG1), there is a limit to a cooling efficiency of the rotary electric machine unit. Therefore, it is desirable to further improve the cooling efficiency of the rotary electric machine unit.

### SUMMARY

The present invention provides a rotary electric machine unit with an improved cooling efficiency.

According to an aspect of the present invention, there is provided a rotary electric machine unit including: a first rotary electric machine that has a first rotation axis extending in a horizontal direction, and includes a first rotor having a substantially annular shape and a first stator including a first stator core having a substantially annular shape surrounding an outer periphery of the first rotor and a first coil mounted on the first stator core; a second rotary electric machine that has a second rotation axis extending in parallel with the first rotation axis and positioned lower than the first rotation axis, and includes a second rotor having a substantially annular shape and a second stator including a second stator core having a substantially annular shape surrounding an outer periphery of the second rotor and a second coil mounted on the second stator core; a first rotation speed detection device that is arranged at a position overlapping with the first rotary electric machine as viewed from an axial direction, and configured to detect a rotation speed of the first rotary electric machine; a second rotation speed detection device that is arranged at a position overlapping with the second rotary electric machine as viewed from the axial direction, and configured to detect a rotation speed of the second rotary electric machine; and a refrigerant supply portion that is arranged at a position upper than the first rotation axis and overlapping with the first rotary electric machine in the axial direction and overlapping with the first rotary electric machine in a left-right direction orthogonal to an upper-lower direction and the axial direction, and configured to supply refrigerant to the first rotary electric machine, where: the first stator core includes a first end surface and a second end surface in the axial direction; the first coil includes a plurality of substantially U-shaped first segment conductors, and includes first coil end portions protruding axially outward from the first end surface and the second end surface of the first stator core; each of the first segment conductors includes a pair of leg portions extending in parallel with each other and having a first end portion and a second end portion, and a curved portion connecting the second end portions of the pair of leg portions, and the first end portion of the leg portion is conducted to the first end portion of the leg portion of different first segment conductor; the first coil end portions include a first open-side coil end portion in which the first end portions of the leg portions of the first segment conductor protrude axially outward from the first end surface of the first stator core, and a first close-side coil end portion in which the curved portion of the first segment conductor protrudes axially outward from the second end surface of the first stator core: the second stator core includes a first end surface and a second end surface in the axial direction, the second coil includes a plurality of substantially U-shaped second segment conductors, and includes second coil end portions protruding axially outward from the first end surface and the second end surface of the second stator core; the second segment conductor includes a pair of leg portions extending in parallel with each other and having a first end portion and a second end portion, and a curved portion connecting the second end portions of the pair of leg portions, and the first end portion of the leg portion is conducted to the first end portion of the leg portion of different second segment conductor; the second coil end portions include a second open-side coil end portion in which the first end portions of the leg portions of the first segment conductor protrude axially outward from the first end surface of the second stator core, and a second close-side coil end portion in which the curved portion of the second segment conductor protrudes axially outward from the second end surface of the second stator core; the first rotary electric machine and the second rotary electric machine are arranged such that the first open-side coil end portion and the second open-side coil end portion are on one axial end side in the axial direction; and the first rotation speed detection device and the second rotation speed detection device are arranged on the one axial end side of the first rotary electric machine and the second rotary electric machine in the axial direction.

According to the aspect of the present invention, the cooling efficiency of the rotary electric machine unit is improved.

### BRIEF DESCRIPTION OF THE DRAWINGS

FIG. 1 is a view of a rotary electric machine unit according to an embodiment of the present invention as viewed from a front side.

FIG. 2 is a perspective view of main parts of a first segment conductor and a second segment conductor mounted on a first stator and a second stator in a first rotary electric machine and a second rotary electric machine of FIG. 1.

FIG. 3 is a view of the first stator and the second stator on which the first segment conductor and the second segment conductor are mounted, as viewed from the outside in a radial direction.

### DESCRIPTION OF EMBODIMENTS

(Overall Configuration of Rotary Electric Machine Unit)

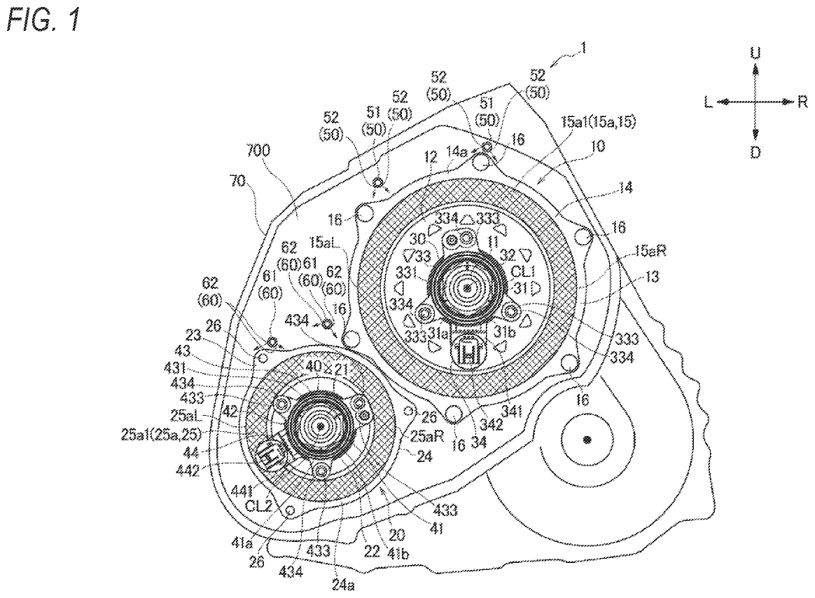

As shown in FIG. 1, the rotary electric machine unit 1 according to the present embodiment includes a first rotary electric machine 10 having a first rotation axis CL1 extending in a horizontal direction, a second rotary electric machine 20 having a second rotation axis CL2 extending in parallel with the first rotation axis CL1, a first resolver 30 for detecting a rotation speed of the first rotary electric machine 10, a second resolver 40 for detecting a rotation speed of the second rotary electric machine 20, a first refrigerant supply portion 50 for supplying refrigerant to the first rotary electric machine 10, a second refrigerant supply portion 60 for supplying refrigerant to the second rotary electric machine 20, and a rotary electric machine housing 70. The rotary electric machine housing 70 includes a rotary electric machine accommodating portion 700. The first rotary electric machine 10, the second rotary electric machine 20, the first resolver 30, the second resolver 40, the first refrigerant supply portion 50, and the second refrigerant supply portion 60 are accommodated in the rotary electric machine accommodating portion 700 of the rotary electric machine housing 70.

In the present specification or the like, a direction parallel to the first rotation axis CL1 of the first rotary electric machine 10 and the second rotation axis CL2 of the second rotary electric machine 20 is referred to as an axial direction of the rotary electric machine unit 1. In addition, in the present specification or the like, in order to simplify and clarify the description, an axial direction is defined as a front-rear direction, and a direction orthogonal to both an upper-lower direction and the front-rear direction (axial direction) is defined as a left-right direction. However, these directions are independent of a direction of a product on which the rotary electric machine unit 1 is mounted. That is, for example, when the rotary electric machine unit 1 is mounted on a vehicle, the front-rear direction of the rotary electric machine unit 1 may coincide with the front-rear direction of the vehicle, may be the left-right direction of the vehicle, or may be a horizontal direction inclined from the front-rear direction and the left-right direction of the vehicle. In the drawings, a front side of the rotary electric machine unit 1 is denoted by Fr, a rear side thereof is denoted by Rr, a left side thereof is denoted by L, a right side thereof is denoted by R, an upper side thereof is denoted by U, and a lower side thereof is denoted by D, respectively.

<Rotary Electric Machine>

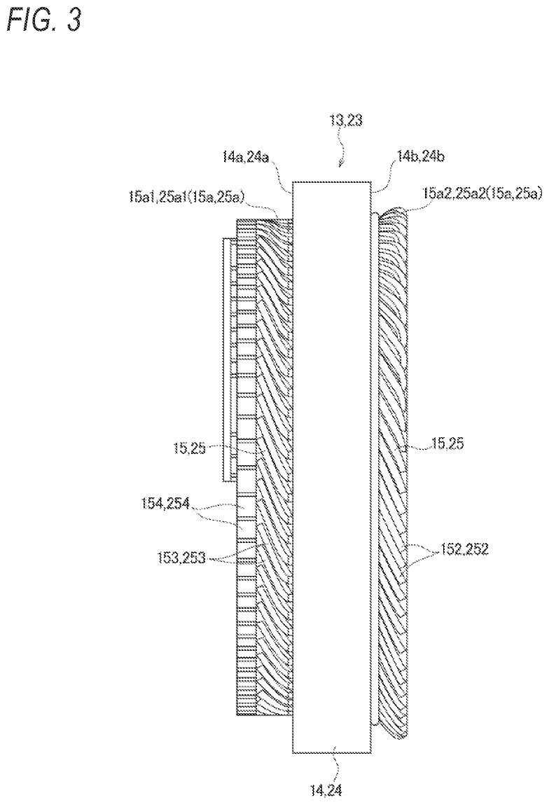

The first rotary electric machine 10 is an electric motor that outputs power. The first rotary electric machine 10 includes a first rotary shaft 11, a substantially annular first rotor 12 press-fitted to the first rotary shaft 11, and a first stator 13 arranged so as to surround an outer periphery of the first rotor 12 and fixed to the rotary electric machine housing 70. The first stator 13 includes a first stator core 14 having a substantially annular shape surrounding the outer periphery of the first rotor 12, and a first coil 15 formed of three phases of a U-phase, a V-phase, and a W-phase mounted on the first stator core 14. The first stator 13 is fixed to the rotary electric machine housing 70 by a fastening member 16. The first stator core 14 includes a first end surface 14a and a second end surface 14b in the axial direction (see FIG. 3). The first coil 15 includes first coil end portions 15a protruding axially outward from the first end surface 14a and the second end surface 14b of the first stator core 14. The first coil end portion 15a has a substantially annular shape centered on the first rotation axis CL1 as viewed from the axial direction, and includes a left end portion 15aL and a right end portion 15aR at a central portion in the upper-lower direction, that is, at substantially the same position as the first rotation axis CL1 in the upper-lower direction.

The second rotary electric machine 20 is a generator that generates power. The second rotary electric machine 20 includes a second rotary shaft 21, a substantially annular second rotor 22 press-fitted to the second rotary shaft 21, and a second stator 23 arranged so as to surround an outer periphery of the second rotor 22 and fixed to the rotary electric machine housing 70. The second stator 23 includes a second stator core 24 having a substantially annular shape surrounding the outer periphery of the second rotor 22, and a second coil 25 formed of three phases of a U-phase, a V-phase, and a W-phase mounted on the second stator core 24. The second stator 23 is fixed to the rotary electric machine housing 70 by a fastening member 26. The second stator core 24 includes a first end surface 24a and a second end surface 24b in the axial direction (see FIG. 3). The second coil 25 includes second coil end portions 25a protruding axially outward from the first end surface 24a and the second end surface 24b of the second stator core 24. The second coil end portion 25a has a substantially annular shape centered on the second rotation axis CL2 as viewed from the axial direction, and includes a left end portion 25aL and a right end portion 25aR at a central portion in the upper-lower direction, that is, at substantially the same position as the second rotation axis CL2 in the upper-lower direction.

Details of the configurations of the first stator 13 and the second stator 23 will be described later.

<Arrangement of Rotary Electric Machine>

The first rotary electric machine 10 and the second rotary electric machine 20 are arranged so as to overlap with each other in the axial direction.

The second rotation axis CL2 of the second rotary electric machine 20 is positioned lower than the first rotation axis CL1 of the first rotary electric machine 10.

The first rotary electric machine 10 and the second rotary electric machine 20 are arranged so as to partially overlap with each other in the upper-lower direction. Accordingly, a dimension of the rotary electric machine unit 1 in the upper-lower direction can be reduced, and the rotary electric machine unit 1 can be reduced in a size.

The second rotary electric machine 20 is arranged such that the second coil end portion 25a overlaps with the left end portion 15aL of the first coil end portion 15a of the first rotary electric machine 10 in the left-right direction as viewed from the axial direction.

The second rotary electric machine 20 is arranged such that the second rotation axis CL2 does not overlap with the first rotary electric machine 10 in the left-right direction as viewed from the axial direction.

<Resolver>

The first resolver 30 is arranged at a position overlapping with the first rotary electric machine 10 as viewed from the axial direction. The first resolver 30 includes a first resolver rotor 31 attached to the first rotary shaft 11 and a first resolver stator 32 attached to the rotary electric machine housing 70. In the present embodiment, the first resolver 30 is provided in front of the first rotor 12 and the first stator 13 of the first rotary electric machine 10.

The first resolver rotor 31 is formed of, for example, a tubular member (electromagnetic steel pipe) of electromagnetic steel. The electromagnetic steel pipe is a steel pipe excellent in magnetic characteristics. The first resolver rotor 31 is formed with a thick portion 31a having a long radial length and a thin portion 31b having a short radial length. The first resolver rotor 31 is fixed to the first rotary shaft 11 by, for example, press-fitting.

The first resolver stator 32 is arranged opposite to an outer side in the radial direction of the first resolver rotor 31, and includes a stator portion 33 having a substantially annular shape centered on the first rotation axis CL1, and a telecom connector portion 34 extending radially outward from the stator portion 33 and protruding forward in the axial direction. In the present embodiment, the telecom connector portion 34 extends downward from the stator portion 33.

An inner peripheral surface of the stator portion 33 is provided with a plurality of detection portions 331 formed so as to extend radially inward and arranged in a ring shape in a peripheral direction. A coil (not shown) is arranged in each of the detection portions 331 inside the stator portion 33.

A plurality of fastening portions 334 are provided on an outer peripheral surface of the stator portion 33 so as to extend radially outward and have bolt insertion holes 333 penetrating in a central axial direction. In the present embodiment, three fastening portions 334 are provided at substantially equal intervals in the peripheral direction on the outer peripheral surface of the stator portion 33.

By inserting fastening bolts into the bolt insertion holes 333 provided in the respective fastening portions 334 of the first resolver stator 32 and fastening the fastening bolts to the rotary electric machine housing 70, the first resolver stator 32 is fixed to the rotary electric machine housing 70.

The telecom connector portion 34 includes an extension portion 341 extending radially outward from the outer peripheral surface of the stator portion 33 to the top and an external connection portion 342 protruding forward from the extension portion 341. The telecom connector portion 34 is formed integrally with the stator portion 33.

The external connection portion 342 includes a terminal portion (not shown) electrically connected to a coil arranged inside the stator portion 33. The external connection portion 342 protrudes to the outside of the rotary electric machine housing 70, and electric power is supplied from the outside of the rotary electric machine unit 1 to the coil arranged inside the stator portion 43 via the terminal portion by connecting a wire harness or the like extending from a control unit or the like outside the rotary electric machine unit 1 to the external connection portion 342.

For example, when a current is supplied to the first coil 15 of the first stator 13 of the first rotary electric machine 10, the first rotor 12 rotates, and the first rotary shaft 11 and the first resolver rotor 31 rotate in accordance with the rotation of the first rotor 12.

When the first resolver rotor 31 rotates, a gap between the first resolver rotor 31 and the first resolver stator 32 is changed by the thick portion 31a and the thin portion 31b of the first resolver rotor 31. When a current is supplied to the coil of the first resolver stator 32, a magnetic field is formed, and an amount of magnetic fluxes changes from place to place as the gap between the first resolver rotor 31 and the first resolver stator 32 changes in accordance with the rotation of the first resolver rotor 31. Rotation speeds of the first rotary shaft 11 and the first rotor 12, that is, the rotation speed of the first rotary electric machine 10 can be detected by detecting a change in the magnetic flux by the detection portion 331 of the first resolver stator 32.

The second resolver 40 is arranged at a position overlapping with the second rotary electric machine 20 as viewed from the axial direction. The second resolver 40 includes a second resolver rotor 41 attached to the second rotary shaft 21 and a second resolver stator 42 attached to the rotary electric machine housing 70. In the present embodiment, the second resolver 40 is provided in front of the second rotor 22 and the second stator 23 of the second rotary electric machine 20.

The second resolver rotor 41 is formed of, for example, a tubular member (electromagnetic steel pipe) of electromagnetic steel. The electromagnetic steel pipe is a steel pipe excellent in magnetic characteristics. The second resolver rotor 41 is formed with a thick portion 41a having a long radial length and a thin portion 41b having a short radial length. The second resolver rotor 41 is fixed to the second rotary shaft 21 by, for example, press-fitting.

The second resolver stator 42 is arranged opposite to an outer side in the radial direction of the second resolver rotor 41, and includes a stator portion 43 having a substantially annular shape centered on the second rotation axis CL2, and a telecom connector portion 44 extending radially outward from the stator portion 43 and protruding forward in the axial direction. In the present embodiment, the telecom connector portion 44 extends from the stator portion 43 in a lower left direction.

An inner peripheral surface of the stator portion 43 is provided with a plurality of detection portions 431 formed so as to extend radially inward and arranged in a ring shape in the peripheral direction. A coil (not shown) is arranged in each of the detection portions 431 inside the stator portion 43.

A plurality of fastening portions 434 are formed on an outer peripheral surface of the stator portion 43 so as to extend radially outward and have bolt insertion holes 433 penetrating in the central axial direction. In the present embodiment, three fastening portions 434 are provided at substantially equal intervals in the peripheral direction on the outer peripheral surface of the stator portion 43.

By inserting fastening bolts into the bolt insertion holes 433 provided in the respective fastening portions 434 of the second resolver stator 42 and fastening the fastening bolts to the rotary electric machine housing 70, the second resolver stator 42 is fixed to the rotary electric machine housing 70.

The telecom connector portion 44 includes an extension portion 441 extending radially outward from the outer peripheral surface of the stator portion 43 to the lower left and an external connection portion 442 protruding forward from the extension portion 441. The telecom connector portion 44 is formed integrally with the stator portion 43.

The external connection portion 442 includes a terminal portion (not shown) electrically connected to a coil arranged inside the stator portion 43. The external connection portion 442 protrudes to the outside of the rotary electric machine housing 70, and electric power is supplied from the outside of the rotary electric machine unit 1 to the coil arranged inside the stator portion 43 via the terminal portion by connecting a wire harness or the like extending from a control unit or the like outside the rotary electric machine unit 1 to the external connection portion 442.

For example, when the second rotor 22 is rotated by power supplied from an external drive source of the rotary electric machine unit 1, the second rotary shaft 21 and the second resolver rotor 41 rotate in accordance with the rotation of the second rotor 22.

When the second resolver rotor 41 rotates, a gap between the second resolver rotor 41 and the second resolver stator 42 is changed by the thick portion 41a and the thin portion 41b of the second resolver rotor 41. When a current is supplied to the coil of the second resolver stator 42, a magnetic field is formed, and an amount of magnetic fluxes changes from place to place as the gap between the second resolver rotor 41 and the second resolver stator 42 changes in accordance with the rotation of the second resolver rotor 41. Rotation speeds of the second rotary shaft 21 and the second rotor 22, that is, the rotation speed of the second rotary electric machine 20 can be detected by detecting a change in the magnetic flux by the detection portion 431 of the second resolver stator 42.

<Refrigerant Supply Portion>

The first refrigerant supply portion 50 includes a pair of first refrigerant supply pipes 51 provided on a left side and a right side of the first rotation axis CL1 of the first rotary electric machine 10 at positions upper than the first rotation axis CL1 of the first rotary electric machine 10 and overlapping with the first rotary electric machine 10 in the left-right direction. Each of the pair of first refrigerant supply pipes 51 extends in parallel with the first rotation axis CL1 from a front surface to a rear surface of the rotary electric machine accommodating portion 700.

Refrigerant discharge holes 52 are provided in the pair of first refrigerant supply pipes 51 at positions overlapping with the first rotary electric machine 10 in the axial direction. Refrigerant such as an automatic transmission fluid (ATF) is supplied to the pair of first refrigerant supply pipes 51 from a refrigerant supply device (not shown). The refrigerant supplied from the refrigerant supply device to the first refrigerant supply pipe 51 is discharged (including dropping and jetting) from the refrigerant discharge hole 52 and supplied to the first rotary electric machine 10 to cool the first rotary electric machine 10.

In the present embodiment, a pair of front and rear refrigerant discharge holes 52 are provided at positions overlapping with the first coil end portions 15a of the first coil 15, which protrude axially outward from both axial end surfaces of the first stator core 14 of the first rotary electric machine 10 in the axial direction. The refrigerant supplied to the first refrigerant supply pipe 51 and discharged from the refrigerant discharge hole 52 is supplied to the first coil end portions 15a on both axial sides of the first rotary electric machine 10, and cools the first coil end portions 15a.

The second refrigerant supply portion 60 includes a pair of second refrigerant supply pipes 61 provided on a left side and a right side of the second rotation axis CL2 of the second rotary electric machine 20 at positions upper than the second rotation axis CL2 of the second rotary electric machine 20 and overlapping with the second rotary electric machine 20 in the left-right direction. Each of the pair of second refrigerant supply pipes 61 extends in parallel with the second rotation axis CL2 from the front surface to the rear surface of the rotary electric machine accommodating portion 700.

Refrigerant discharge holes 62 are provided in the pair of second refrigerant supply pipes 61 at positions overlapping with the second rotary electric machine 20 in the axial direction. Refrigerant such as an automatic transmission fluid (ATF) is supplied to the pair of second refrigerant supply pipes 61 from a refrigerant supply device (not shown). The refrigerant supplied from the refrigerant supply device to the second refrigerant supply pipe 61 is discharged (including dropping and jetting) from the refrigerant discharge hole 62 and supplied to the second rotary electric machine 20 to cool the second rotary electric machine 20.

In the present embodiment, a pair of front and rear refrigerant discharge holes 62 are provided at positions overlapping with the second coil end portions 25a of the second coil 25, which protrude axially outward from both axial end surfaces of the second stator core 24 of the second rotary electric machine 20 in the axial direction. The refrigerant supplied to the second refrigerant supply pipe 61 and discharged from the refrigerant discharge hole 62 is supplied to the second coil end portions 25a on both axial sides of the second rotary electric machine 20, and cools the second coil end portions 25a.

<Flow of Refrigerant>

Most of the refrigerant discharged from the refrigerant discharge hole 52 of the first refrigerant supply pipe 51 flows downward in the left-right direction along the first coil end portion 15a of the first coil 15 while flowing downward. Further, most of the refrigerant that has reached the left end portion 15aL and the right end portion 15aR positioned at the central portion in the upper-lower direction of the first coil end portion 15a is separated from the first coil end portion 15a and flows down substantially vertically downward due to gravity.

On the other hand, at a front side of the first rotary electric machine 10, a part of the refrigerant discharged from the refrigerant discharge hole 52 of the first refrigerant supply pipe 51 passes through the first coil end portion 15a of the first coil 15, a part thereof flows to the first resolver stator 32, and a part thereof flows to the first rotary shaft 11, a front side surface of the first rotor 12 and the first resolver rotor 31.

The refrigerant that has flowed to the first resolver stator 32 flows through the first resolver stator 32, partly flows to the second rotary electric machine 20, and partly flows downward from a lower end of the first resolver stator 32, and is supplied to a lower end portion of the first coil end portion 15a. In addition, the refrigerant that has flowed to the first rotary shaft 11, the front side surface of the first rotor 12, and the first resolver rotor 31 is scattered radially outward due to the rotation of the first resolver rotor 31 or the like, and is supplied to the first coil end portion 15a.

Most of the refrigerant discharged from the refrigerant discharge hole 62 of the second refrigerant supply pipe 61 flows downward in the left-right direction along the second coil end portion 25a of the second coil 25 while flowing downward. Further, most of the refrigerant that has reached the left end portion 25aL and the right end portion 25aR positioned at the central portion in the upper-lower direction of the second coil end portion 25a is separated from the second coil end portion 25a and flows down substantially vertically downward due to gravity.

On the other hand, at a front side of the second rotary electric machine 20, a part of the refrigerant discharged from the refrigerant discharge hole 62 of the second refrigerant supply pipe 61 passes through the second coil end portion 25a of the second coil 25, and a part thereof flows to the second resolver stator 42, and a part thereof flows to the second rotary shaft 21, a front side surface of the second rotor 22 and the second resolver rotor 41.

The refrigerant that has flowed to the second resolver stator 42 flows through the second resolver stator 42, and partly flows downward from a lower end of the first resolver stator 32, and is supplied to the lower end portion of the second coil end portion 25a. In addition, the refrigerant that has flowed to the second rotary shaft 21, the front side surface of the second rotor 22, and the second resolver rotor 41 is scattered radially outward due to the rotation of the second resolver rotor 41 or the like, and is supplied to the second coil end portion 25a.

In the present embodiment, the second rotation axis CL2 of the second rotary electric machine 20 is positioned lower than the first rotation axis CL1 of the first rotary electric machine 10, that is, the second rotary electric machine 20 is positioned lower than the first rotary electric machine 10. Therefore, a part of the refrigerant discharged from the refrigerant discharge hole 52 of the first refrigerant supply pipe 51 is supplied to the second rotary electric machine 20 through the first resolver stator 32. Therefore, in addition to the refrigerant discharged from the refrigerant discharge hole 62 of the second refrigerant supply pipe 61, a part of the refrigerant discharged from the refrigerant discharge hole 52 of the first refrigerant supply pipe 51 is also supplied to the second rotary electric machine 20. As a result, in the rotary electric machine unit 1, a cooling efficiency of the second rotary electric machine 20 can be improved without lowering a cooling efficiency of the first rotary electric machine 10, so that a cooling efficiency of the rotary electric machine unit 1 is improved.

In addition, since the first rotary electric machine 10 is an electric motor that outputs power and the second rotary electric machine 20 is a generator that generates power, the electric motor required to have a high cooling effect is arranged above, and the generator required to have a low cooling effect than the electric motor is arranged below. Accordingly, the refrigerant having a low temperature discharged from the refrigerant discharge hole 52 of the first refrigerant supply pipe 51 can be supplied to the first rotary electric machine 10, which is an electric motor, and the second rotary electric machine 20, which is a generator, has a cooling effect even with the refrigerant after passing through the electric motor, thereby further improving the cooling efficiency of the rotary electric machine unit 1.

The second rotary electric machine 20 is arranged such that the second coil end portion 25a overlaps with the left end portion 15aL of the first coil end portion 15a of the first rotary electric machine 10 in the left-right direction as viewed from the axial direction. Therefore, the refrigerant discharged from the refrigerant discharge hole 52 of the first refrigerant supply pipe 51, flowing along the first coil end portion 15a of the first coil 15, and flowing down from the left end portion 15aL of the first coil end portion 15a is supplied to the second coil end portion 25a of the second rotary electric machine 20. As a result, more refrigerant discharged from the refrigerant discharge hole 52 of the first refrigerant supply pipe 51 can be supplied to the second coil end portion 25a of the second rotary electric machine 20, so that the cooling efficiency of the rotary electric machine unit 1 is further improved.

Since the second rotary electric machine 20 is arranged such that the second rotation axis CL2 does not overlap with the first rotary electric machine 10 in the left-right direction as viewed from the axial direction, the first rotary electric machine 10 does not exist at an upper end portion of the second rotary electric machine 20. Therefore, the second refrigerant supply pipe 61 of the second refrigerant supply portion 60 can be easily arranged above the upper end portion of the second rotary electric machine 20. As a result, the refrigerant having a lower temperature from the second refrigerant supply portion 60 that has not passed through the first rotary electric machine 10 can be supplied from the upper end portion of the second rotary electric machine 20, so that the cooling efficiency of the second rotary electric machine 20 can be further improved and the cooling efficiency of the rotary electric machine unit 1 can be further improved.

<Details of Configuration of Stator>

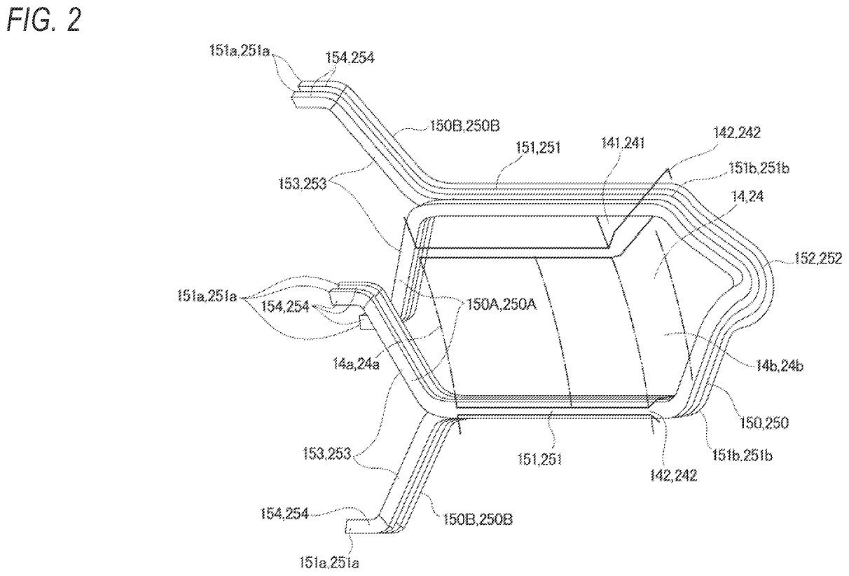

As shown in FIGS. 2 and 3, the first stator core 14 has a substantially annular shape, and includes a plurality of first teeth 141 protruding radially inward at predetermined intervals along the peripheral direction, and a plurality of first slots 142 that are spaces between adjacent first teeth 141 in the peripheral direction. The first stator core 14 includes a first end surface 14a and a second end surface 14b in the axial direction.

The first coil 15 is formed of a plurality of substantially U-shaped first segment conductors 150 respectively inserted into the plurality of first slots 142.

The first segment conductor 150 includes a pair of leg portions 151 extending in parallel with each other, and a curved portion 152 connecting the pair of leg portions 151, and has a substantially U shape. Each of the pair of leg portions 151 includes a first end portion 151a and a second end portion 151b, and the curved portion 152 connects the second end portions 151b of the pair of leg portions 151. The first segment conductor 150 is arranged such that the pair of leg portions 151 are respectively inserted into different first slots 142 of the first stator core 14, the curved portions 152 protrude axially outward from the second end surface 14b of the first stator core 14, and the first end portions 151a of the pair of leg portions 151 protrude axially outward from the first end surface 14a of the first stator core 14.

Protruding portions of the pair of leg portions 151 on a first end portion 151a side, which protrude axially outward from the first end surface 14a of the first stator core 14, are bent in the peripheral direction of the first stator core 14 by a jig (not shown) holding front end portions of the first end portions 151a and rotating relative to the first stator core 14 in the peripheral direction while approaching the first stator core 14 in the axial direction. As a result, the protruding portions of the first end portions 151a of the pair of leg portions 151 are formed with oblique portions 153 that bend and extend in a direction toward each other or away from each other in the peripheral direction of the first stator core 14 and front end portions 154 that extend outward in the axial direction of the first stator core 14 from front ends of the oblique portions 153, which are front end portions of the first end portions 151a held by the jig, respectively.

The first segment conductor 150 formed in this manner includes a lap-wound segment conductor 150A in which the oblique portions 153 are skewed in a direction in which the front end portions 154 formed on the first end portions 151a of the pair of leg portions 151 approach each other, and a wave-wound segment conductor 150B in which the oblique portions 153 are skewed in a direction in which the front end portions 154 formed on the first end portions 151a of the pair of leg portions 151 are separated from each other.

A plurality of lap-wound segment conductors 150A and wave-wound segment conductors 150B are inserted into the first slots 142. At this time, the plurality of lap-wound segment conductors 150A and wave-wound segment conductors 150B are arranged such that the leg portions 151 are arranged in a row in the radial direction in the first slot 142.

The front end portions 154 of the lap-wound segment conductor 150A and the wave-wound segment conductor 150B inserted into the first slots 142 are joined by, for example, laser welding to the front end portions 154 of the lap-wound segment conductor 150A or the wave-wound segment conductor 150B inserted into the different first slots 142 to be conductive.

In this way, the plurality of first segment conductors 150 (the lap-wound segment conductor 150A and wave-wound segment conductor 150B) are inserted into the plurality of first slots 142 provided in the first stator core 14, and the respective front end portions 154 are joined and conducted to the front end portions 154 of the different first segment conductors 150, thereby forming the first coil 15.

The oblique portions 153 and the front end portions 154 of each of the first segment conductors 150 form first open-side coil end portions 15al protruding axially outward from the first end surface 14a of the first stator core 14. The curved portion 152 of each of the first segment conductors 150 forms a first close-side coil end portion 15a2 protruding axially outward from the second end surface 14b of the first stator core 14.

In this manner, the first coil end portion 15a includes the first open-side coil end portion 15al and the first close-side coil end portion 15a2.

Similarly, the second stator core 24 has a substantially annular shape, and includes a plurality of second teeth 241 protruding radially inward at predetermined intervals along the peripheral direction, and a plurality of second slots 242 that are spaces between adjacent second teeth 241 in the peripheral direction. The second stator core 24 includes a first end surface 24a and a second end surface 24b in the axial direction.

The second coil 25 is formed of a plurality of substantially U-shaped second segment conductors 250 respectively inserted into the plurality of second slots 242.

The second segment conductor 250 includes a pair of leg portions 251 extending in parallel with each other, and a curved portion 252 connecting the pair of leg portions 251, and has a substantially U shape. Each of the pair of leg portions 251 includes a first end portion 251a and a second end portion 251b, and the curved portion 252 connects the second end portions 251b of the pair of leg portions 251. The second segment conductor 250 is arranged such that the pair of leg portions 251 are respectively inserted into different second slots 242 of the second stator core 24, and the curved portions 252 protrude axially outward from the second end surface 24b of the second stator core 24, and the first end portions 251a of the pair of leg portions 251 protrude axially outward from the first end surface 24a of the second stator core 24.

Protruding portions of the pair of leg portions 251 on a first end portion 251a side, which protrude axially outward from the first end surface 24a of the second stator core 24, are bent in the peripheral direction of the second stator core 24 by a jig (not shown) holding front end portions of the first end portions 251a and rotating relative to the second stator core 24 in the peripheral direction while approaching the second stator core 24 in the axial direction. As a result, the protruding portions of the first end portions 251a of the pair of leg portions 251 are formed with oblique portion 253 that bend and extend in a direction toward each other or away from each other in the peripheral direction of the second stator core 24 and front end portions 254 that extend outward in the axial direction of the second stator core 24 from front ends of the oblique portions 153, which are front end portions of the first end portions 251a held by the jig, respectively.

The second segment conductor 250 formed in this manner includes a lap-wound segment conductor 250A in which the oblique portions 253 are skewed in a direction in which the front end portions 254 formed at the first end portions 251a of the pair of leg portions 251 approaches each other, and a wave-wound segment conductor 250B in which the oblique portions 253 are skewed in a direction in which the front end portions 254 formed on the first end portions 251a of the pair of leg portions 251 are separated from each other.

A plurality of lap-wound segment conductors 250A and wave-wound segment conductors 250B are inserted into the second slots 242. At this time, the plurality of lap-wound segment conductors 250A and the wave-wound segment conductors 250B are arranged such that the leg portions 251 are arranged in a row in the radial direction in the second slot 242.

The front end portions 254 of the lap-wound segment conductor 250A and the wave-wound segment conductor 250B inserted into the second slots 242 are joined by, for example, laser welding to the front end portions 254 of the lap-wound segment conductor 250A or the wave-wound segment conductor 250B inserted into the different second slots 242 to be conductive.

In this way, the plurality of second segment conductors 250 (the lap-wound segment conductor 250A and wave-wound segment conductor 250B) are inserted into the plurality of second slots 242 provided in the second stator core 24, and the respective front end portions 254 are joined and conducted to the front end portions 254 of the different second segment conductors 250, thereby forming the second coil 25.

The oblique portions 253 and the front end portions 254 of each of the second segment conductors 250 form second open-side coil end portion 25al protruding axially outward from the first end surface 24a of the second stator core 24. The curved portion 252 of each of the second segment conductors 250 forms a second close-side coil end portion 25a2 protruding axially outward from the second end surface 24b of the second stator core 24.

In this manner, the second coil end portion 25a includes the second open-side coil end portion 25al and the second close-side coil end portion 25a2.

In the first coil 15 and the second coil 25 formed in this manner, since the first open-side coil end portion 15al and the second open-side coil end portion 25al are formed with the front end portions 154, 254 for joining different first segment conductors 150 and the second segment conductors 250, respectively, the first open-side coil end portion 15al and the second open-side coil end portion 25al protrude axially toward an outer side than the first close-side coil end portion 15a2 and the second close-side coil end portion 25a2. Further, since the first open-side coil end portion 15al and the second open-side coil end portion 25al are conducted to the different first segment conductor 150 and second segment conductor 250 by joining, the first open-side coil end portion 15al and the second open-side coil end portion 25al have higher electric resistance than the first close-side coil end portion 15a2 and the second close-side coil end portion 25a2. Therefore, when the first rotary electric machine 10 and the second rotary electric machine 20 are driven, the first open-side coil end portion 15al and the second open-side coil end portion 25al generate a larger amount of heat than the first close-side coil end portion 15a2 and the second close-side coil end portion 25a2.

Returning to FIG. 1, the first rotary electric machine 10 and the second rotary electric machine 20 are arranged such that the first open-side coil end portion 15al and the second open-side coil end portion 25al are on the front side in the axial direction. The first resolver 30 and the second resolver 40 are arranged on the front side of the first rotary electric machine 10 and the second rotary electric machine 20 in the axial direction. As described above, the first open-side coil end portion 15al and the second open-side coil end portion 25al of the first rotary electric machine 10 and the second rotary electric machine 20 are arranged on the same side in the axial direction, and the first resolver 30 and the second resolver 40 are both arranged on the same side as the side where the first open-side coil end portion 15al and the second open-side coil end portion 25al are arranged in the axial direction.

Therefore, the refrigerant flowing downward from the lower end of the first resolver stator 32 through the first resolver stator 32 is supplied to a lower end portion of the first open-side coil end portion 15al having a larger heat generation amount. In addition, the refrigerant that has flowed into the first rotary shaft 11, the front side surface of the first rotor 12, and the first resolver rotor 31 is scattered radially outward due to rotation of the first resolver rotor 31 or the like, and is supplied to the first open-side coil end portion 15al having a larger heat generation amount.

As a result, more refrigerant can be supplied to the first open-side coil end portion 15al having a larger heat generation amount, so that the cooling efficiency of the rotary electric machine unit 1 is further improved.

Similarly, the refrigerant flowing downward from the lower end of the second resolver stator 42 through the second resolver stator 42 is supplied to a lower end portion of the second open-side coil end portion 25al having a higher heat generation amount. Further, the refrigerant that has flowed into the second rotary shaft 21, the front side surface of the second rotor 22, and the second resolver rotor 41 is scattered radially outward due to the rotation of the second resolver rotor 41 or the like, and is supplied to the second open-side coil end portion 25al having a larger heat generation amount.

Further, the refrigerant discharged from the refrigerant discharge hole 52 of the first refrigerant supply pipe 51 and supplied to the second rotary electric machine 20 through the first resolver stator 32 is supplied to the second open-side coil end portion 25al having a higher heat generation amount.

As a result, more refrigerant can be supplied to the second open-side coil end portion 25al having a higher heat generation amount, so that the cooling efficiency of the rotary electric machine unit 1 is further improved.

Although the embodiment of the present invention has been described above, the present invention is not limited to the above-described embodiment, and modifications, improvements, or the like can be made as appropriate.

At least the following matters are described in the present specification. Although corresponding constituent elements or the like in the above embodiment are shown in parentheses, the present invention is not limited thereto.

(1) A rotary electric machine unit (rotary electric machine unit 1) including:

a first rotary electric machine (first rotary electric machine 10) that has a first rotation axis (first rotation axis CL1) extending in a horizontal direction, and includes a first rotor (first rotor 12) having a substantially annular shape and a first stator (first stator 13) including a first stator core (stator core 14) having a substantially annular shape surrounding an outer periphery of the first rotor and a first coil (first coil 15) mounted on the first stator core;

a second rotary electric machine (second rotary electric machine 20) that has a second rotation axis (second rotation axis CL2) extending in parallel with the first rotation axis and positioned lower than the first rotation axis, and includes a second rotor (second rotor 22) having a substantially annular shape and a second stator (second stator 23) including a second stator core (second stator core 24) having a substantially annular shape surrounding an outer periphery of the second rotor and a second coil (second coil 25) mounted on the second stator core;

a first rotation speed detection device (first resolver 30) that is arranged at a position overlapping with the first rotary electric machine as viewed from an axial direction, and configured to detect a rotation speed of the first rotary electric machine;

a second rotation speed detection device (second resolver 40) that is arranged at a position overlapping with the second rotary electric machine as viewed from the axial direction and configured to detect a rotation speed of the second rotary electric machine; and

a refrigerant supply portion (first refrigerant supply portion 50) that is arranged at a position upper than the first rotation axis and overlapping with the first rotary electric machine in the axial direction and overlapping with the first rotary electric machine in a left-right direction orthogonal to an upper-lower direction and the axial direction, and configured to supply refrigerant to the first rotary electric machine, where:

the first stator core includes a first end surface (first end surface 14a) and a second end surface (second end surface 14b) in the axial direction;

the first coil includes a plurality of substantially U-shaped first segment conductors (first segment conductors 150), and includes first coil end portions (first coil end portion 15a) protruding axially outward from the first end surface and the second end surface of the first stator core:

each of the first segment conductors includes a pair of leg portions (leg portions 151) extending in parallel with each other and having a first end portion (first end portion 151a) and a second end portion (second end portion 151b) and a curved portion (curved portion 152) connecting the second end portions of the pair of leg portions, and the first end portion of the leg portion is conducted to the first end portion of the leg portion of different first segment conductor:

the first coil end portions include a first open-side coil end portion (first open-side coil end portion 15al) in which the first end portions of the leg portions of the first segment conductor protrude axially outward from the first end surface of the first stator core, and a first close-side coil end portion (first close-side coil end portion 15a2) in which the curved portion of the first segment conductor protrudes axially outward from the second end surface of the first stator core:

the second stator core includes a first end surface (first end surface 24a) and a second end surface (second end surface 24b) in the axial direction:

the second coil includes a plurality of substantially U-shaped second segment conductors (second segment conductors 250), and includes second coil end portions (second coil end portion 25a) protruding axially outward from the first end surface and the second end surface of the second stator core;

the second segment conductor includes a pair of leg portions (leg portions 251) extending in parallel with each other and having a first end portion (first end portion 251a) and a second end portion (second end portion 251b), and a curved portion (curved portion 252) connecting the second end portions of the pair of leg portions, and the first end portion of the leg portion is conducted to the first end portion of the leg portion of different second segment conductor;

the second coil end portions include a second open-side coil end portion (second open-side coil end portion 25al) in which the first end portions of the leg portions of the first segment conductor protrude axially outward from the first end surface of the second stator core, and a second close-side coil end portion (second close-side coil end portion 25a2) in which the curved portion of the second segment conductor protrudes axially outward from the second end surface of the second stator core:

the first rotary electric machine and the second rotary electric machine are arranged such that the first open-side coil end portion and the second open-side coil end portion are on one axial end side (front side) in the axial direction; and the first rotation speed detection device and the second rotation speed detection device are arranged on the one axial end side of the first rotary electric machine and the second rotary electric machine in the axial direction.

According to (1), the second rotation axis of the second rotary electric machine is positioned lower than the first rotation axis of the first rotary electric machine, that is, the second rotary electric machine is positioned lower than the first rotary electric machine. Therefore, a part of the refrigerant supplied from the refrigerant supply portion is supplied to the second rotary electric machine through the first rotation speed detection device. Therefore, a part of the refrigerant supplied from the refrigerant supply portion is supplied to the second rotary electric machine. As a result, a cooling efficiency of the second rotary electric machine is improved, thereby improving a cooling efficiency of the rotary electric machine unit.

Further, since the refrigerant supplied from the refrigerant supply portion and flowing into the first rotation speed detection device can be supplied to the first open-side coil end portion and the second open-side coil end portion having a larger heat generation amount, the cooling efficiency of the rotary electric machine unit is further improved. In addition, since the refrigerant that has flowed into the second rotation speed detection device can be supplied to the second open-side coil end portion having a larger heat generation amount, the cooling efficiency of the rotary electric machine unit is further improved.

(2) The rotary electric machine unit according to (1), where

the first rotary electric machine and the second rotary electric machine are arranged so as to partially overlap with each other in the upper-lower direction as viewed from the axial direction.

According to (2), since the first rotary electric machine and the second rotary electric machine are arranged so as to partially overlap with in the upper-lower direction, a dimension of the rotary electric machine unit in the upper-lower direction can be reduced, and the rotary electric machine unit can be reduced in a size.

(3) The rotary electric machine unit according to (1) or (2), where

the second rotary electric machine is arranged such that the second coil end portion overlaps with at least one end portion (left end portion 15aL) of the first coil end portion of the first rotary electric machine in the left-right direction as viewed from the axial direction.

According to (3), the second rotary electric machine is arranged such that the second coil end portion overlaps with at least one end portion of the first coil end portion of the first rotary electric machine in the left-right direction as viewed from the axial direction. Therefore, the refrigerant supplied from the refrigerant supply portion, flowing along the first coil end portion of the first coil and flowing down from the end portion on one side in the left-right direction of the first coil end portion is supplied to the second coil end portion of the second rotary electric machine. As a result, more refrigerant supplied from the refrigerant supply portion can be supplied to the second coil end portion of the second rotary electric machine, so that the cooling efficiency of the rotary electric machine unit is further improved.

(4) The rotary electric machine unit according to any one of (1) to (3), where

the second rotary electric machine is arranged such that the second rotation axis does not overlap with the first rotary electric machine in the left-right direction as viewed from the axial direction.

According to (4), since the second rotary electric machine is arranged such that the second rotation axis does not overlap with the first rotary electric machine in the left-right direction as viewed from the axial direction, the first rotary electric machine does not exist at an upper end portion of the second rotary electric machine. Therefore, a separate refrigerant supply portion can be easily arranged above the upper end portion of the second rotary electric machine. As a result, the refrigerant having a lower temperature from the second refrigerant supply portion that has not passed through the first rotary electric machine can be supplied from the upper end portion of the second rotary electric machine, so that the cooling efficiency of the second rotary electric machine can be further improved and the cooling efficiency of the rotary electric machine unit can be further improved.

(5) The rotary electric machine unit according to any one of (1) to (4), where:

the first rotary electric machine is an electric motor configured to output power; and

the second rotary electric machine is a generator configured to generates power.

According to (5), since the first rotary electric machine is an electric motor configured to output power and the second rotary electric machine is a generator configured to generate power, the electric motor required to have a high cooling effect is arranged above, and the generator required to have a low cooling effect than the electric motor is arranged below. Accordingly, the refrigerant having a low temperature supplied from the refrigerant supply portion can be supplied to the first rotary electric machine, which is an electric motor, and the second rotary electric machine, which is a generator, and the second rotary electric machine, which is a generator, has a cooling effect even with the refrigerant after passing through the electric motor, thereby further improving the cooling efficiency of the rotary electric machine unit.

1. A rotary electric machine unit comprising:
a first rotary electric machine that has a first rotation axis extending in a horizontal direction, and includes a first rotor having a substantially annular shape and a first stator including a first stator core having a substantially annular shape surrounding an outer periphery of the first rotor and a first coil mounted on the first stator core;
a second rotary electric machine that has a second rotation axis extending in parallel with the first rotation axis and positioned lower than the first rotation axis, and includes a second rotor having a substantially annular shape and a second stator including a second stator core having a substantially annular shape surrounding an outer periphery of the second rotor and a second coil mounted on the second stator core;
a first rotation speed detection device that is arranged at a position overlapping with the first rotary electric machine as viewed from an axial direction, and configured to detect a rotation speed of the first rotary electric machine;
a second rotation speed detection device that is arranged at a position overlapping with the second rotary electric machine as viewed from the axial direction, and configured to detect a rotation speed of the second rotary electric machine; and
a refrigerant supply portion that is arranged at a position upper than the first rotation axis and overlapping with the first rotary electric machine in the axial direction and overlapping with the first rotary electric machine in a left-right direction orthogonal to an upper-lower direction and the axial direction, and configured to supply refrigerant to the first rotary electric machine, wherein:
the first stator core includes a first end surface and a second end surface in the axial direction;
the first coil includes a plurality of substantially U-shaped first segment conductors, and includes first coil end portions protruding axially outward from the first end surface and the second end surface of the first stator core;
each of the first segment conductors includes a pair of leg portions extending in parallel with each other and having a first end portion and a second end portion, and a curved portion connecting the second end portions of the pair of leg portions, and the first end portion of the leg portion is conducted to the first end portion of the leg portion of different first segment conductor;
the first coil end portions include a first open-side coil end portion in which the first end portions of the leg portions of the first segment conductor protrude axially outward from the first end surface of the first stator core, and a first close-side coil end portion in which the curved portion of the first segment conductor protrudes axially outward from the second end surface of the first stator core;
the second stator core includes a first end surface and a second end surface in the axial direction;
the second coil includes a plurality of substantially U-shaped second segment conductors, and includes second coil end portions protruding axially outward from the first end surface and the second end surface of the second stator core;
the second segment conductor includes a pair of leg portions extending in parallel with each other and having a first end portion and a second end portion, and a curved portion connecting the second end portions of the pair of leg portions, and the first end portion of the leg portion is conducted to the first end portion of the leg portion of different second segment conductor;
the second coil end portions include a second open-side coil end portion in which the first end portions of the leg portions of the first segment conductor protrude axially outward from the first end surface of the second stator core, and a second close-side coil end portion in which the curved portion of the second segment conductor protrudes axially outward from the second end surface of the second stator core;
the first rotary electric machine and the second rotary electric machine are arranged such that the first open-side coil end portion and the second open-side coil end portion are on one axial end side in the axial direction; and
the first rotation speed detection device and the second rotation speed detection device are arranged on the one axial end side of the first rotary electric machine and the second rotary electric machine in the axial direction.

2. The rotary electric machine unit according to claim 1, wherein
the first rotary electric machine and the second rotary electric machine are arranged so as to partially overlap with each other in the upper-lower direction as viewed from the axial direction.

3. The rotary electric machine unit according to claim 1, wherein
the second rotary electric machine is arranged such that the second coil end portion overlaps with at least one end portion of the first coil end portion of the first rotary electric machine in the left-right direction as viewed from the axial direction.

4. The rotary electric machine unit according to claim 1, wherein
the second rotary electric machine is arranged such that the second rotation axis does not overlap with the first rotary electric machine in the left-right direction as viewed from the axial direction.

5. The rotary electric machine unit according to claim 1, wherein:
the first rotary electric machine is an electric motor configured to output power; and
the second rotary electric machine is a generator configured to generates power.
